(19) United States
(12) Patent Application Publication
(10) Pub. No.: US 2023/0089957 A1
(43) Pub. Date: Mar. 23, 2023

(54) Current-Voltage Driving for LED Display System

(71) Applicant: Apple Inc., Cupertino, CA (US)

(72) Inventors: Thomas Charisoulis, San Carlos, CA (US); Saif Choudhary, San Jose, CA (US); Tore Nauta, Santa Cruz, CA (US)

(21) Appl. No.: 17/887,136

(22) Filed: Aug. 12, 2022

Related U.S. Application Data
(60) Provisional application No. 63/247,189, filed on Sep. 22, 2021.

(51) Int. Cl. G09G 3/32; H05B 45/14

(52) U.S. Cl. CPC G09G 3/32; H05B 45/14

(57) ABSTRACT

A display device includes a voltage source that provides a voltage and a current source that provides a current. The display device also includes light emitting diodes (LEDs) that emit light to display an image on the display device. Additionally, the display device includes pixel driving circuitry that drives the LEDs using the voltage or the current. In particular, the pixel driving circuitry provides the LEDs with the voltage from the voltage source for a first period of time to enable the LEDs to reach an illumination threshold. Moreover, the pixel driving circuitry, after providing the voltage from the voltage source for the first period of time, drives the LEDs using the current from the current source to cause the LEDs to emit light substantially uninterrupted when changing between providing the voltage from the voltage source to driving the one or more LEDs using the current source.

### CROSS-REFERENCE TO RELATED APPLICATIONS

This application claims priority to U.S. Provisional Application No. 63/247,189, filed Sep. 22, 2021, entitled “Current-Voltage Driving for LED Display System,” the disclosure of which is incorporated herein by reference in its entirety for all purposes.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure relates generally to systems and devices for providing a uniform output from light emitting diodes (LEDs) of a display. In particular, to provide a constant charge per unit time to the LEDs, for example, so that actual response of the LEDs is the same or approximately the same as the average response of the LEDs, the systems and methods described herein may use a current and voltage driving (IV driving) circuit to drive the LEDs. The IV driving may be less sensitive (e.g., substantially insensitive) to capacitance.

As described herein, in some embodiments, the IV driving circuit may include one or more discharge switches. The discharge switch may discharge the internal capacitors of the respective LEDs to the turn on voltage of the LEDs or below turn on voltage of the LEDs. Additionally or alternatively, the IV driving circuit may selectively enable driving one or more LEDs of multiple LEDs. The LEDs may be charged and/or driven in phases (e.g., a first phase, a second phase, a third phase, and so forth). Moreover, the IV driving circuit may apply a pre-charge potential to LEDs from a voltage-follower topology that connects to higher voltage lines, reducing or preventing the effects of capacitance on pulse width responses of the LEDs.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an electronic device, according to an embodiment of the present disclosure;

FIG. 2 is a perspective view of a notebook computer representing an embodiment of the electronic device of FIG. 1;

FIG. 3 is a front view of a handheld device representing another embodiment of the electronic device of FIG. 1;

FIG. 4 is a front view of another handheld device representing another embodiment of the electronic device of FIG. 1;

FIG. 5 is a front view of a desktop computer representing another embodiment of the electronic device of FIG. 1;

FIG. 6 is a front view and side view of a wearable electronic device representing another embodiment of the electronic device of FIG. 1;

FIG. 7 is a block diagram of a μ-LED display that employs micro-drivers (μDs) to drive μ-LED sub-pixels with control signals from row drivers (RDs) and data signals from column drivers (CDs), according to embodiments of the present disclosure;

FIG. 8 a schematic diagram of a current-voltage circuit for current-voltage driving, according to embodiments of the present disclosure;

FIG. 9 is a timing diagram corresponding to the current-voltage circuit of FIG. 8, according to embodiments of the present disclosure;

FIG. 10 is a graph of illustrating a nits floor for the current-voltage driving, according to embodiments of the present disclosure;

FIG. 11 is schematic diagram of a current-voltage circuit with discharging switches for actively discharging light emitting diodes, according to embodiments of the present disclosure;

FIG. 12 is a timing diagram corresponding to the current-voltage circuit with the discharging switches of FIG. 8, according to embodiments of the present disclosure;

FIG. 13 is a schematic diagram of the current-voltage circuit for driving light emitting diodes at different times of a frame, according to embodiments of the present disclosure;

FIG. 14 is a timing diagram corresponding to the current-voltage circuit implemented in the display of FIG. 13, according to embodiments of the present disclosure;

FIG. 15 is a schematic diagram of the driving threshold voltage (Vth) sampling circuit for light emitting diodes having varying forward operating voltages, according to embodiments of the present disclosure; and

FIG. 16 is a timing diagram corresponding to the voltage driving Vth sampling circuit for the light emitting diodes having varying forward operating voltages of FIG. 15, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment”, “an embodiment”, or “some embodiments” of the present disclosure are not intended to be interpreted as excluding the existence of additional embodiments that also incorporate the recited features. Use of the term “approximately” or “near” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on).

The present disclosure provides techniques for reducing or preventing impact of capacitance of light emitting diodes (LEDs) on pulse width responses from the LEDs. In this manner, the techniques described herein may provide linear pulse width responses across the LEDs of a display panel, may provide a constant or approximately constant nits ratio between multiple LEDs (e.g., including wide range of pulse widths), and may enable drivers to drive LEDs at rounded corners of the display without perceivable artifacts due to the pulse width response being less affected by capacitance. In particular, and as previously mentioned, some electronic displays may include capacitors charging LEDs. These capacitors, for the LEDs programmed with higher gray levels (e.g., brighter LEDs), may take a relatively longer time to charge, and the higher capacitance may result in more nonlinearity. That is, a higher capacitance corresponds to a more non-uniform or nonlinear LED output response (e.g., luminance). The non-uniformity may result in perceivable artifacts on the display. In some instances, the non-uniformity across the LEDs, such as from the varying capacitance of the capacitors charging the LEDs, may be corrected by applying a uniformity correction step prior to rendering images.

In particular, the uniformity correction may include individually and independently scaling (e.g., extending or shortening) each of the pulse widths for driving each of the LEDs. For example, the correction may include scaling up the pulse width for driving dimmer LEDs emitting at relatively lower gray levels, scaling down the pulse width for driving brighter LEDs emitting at relatively higher gray levels, or both. Specifically, the correction is based on a ratio of the deviation of the actual light response from the LEDs to an average light response from the LEDs. Often, especially for high capacitance, the ratio may fluctuate and not be constant. Moreover, the ratio changes may occur at high gray levels, where the non-uniformity is perceivable on the display.

To provide a constant charge per unit time to the LEDs so that their actual response is the same or approximately the same as the average response (e.g., ratio of 1 or approximately 1), systems and methods described herein may use current and voltage driving (IV driving) for the LEDs that is less sensitive (e.g., substantially insensitive) to capacitance. As described herein, in some embodiments, the current and voltage driving circuit may include one or more discharge switches. The discharge switch discharges the capacitor of the LED to the turn on voltage of the LED or below the LED turn on voltage. Additionally or alternatively, the current and voltage driving circuit may selectively enable driving one or more LEDs of multiple LEDs. The LEDs may be charged and/or driven in phases (e.g., a first phase, a second phase, a third phase, and so forth). Moreover, the current and voltage driving circuit may apply a pre-charge potential to LEDs from a voltage-follower topology that connects to higher voltage lines, reducing or preventing the effects of capacitance on pulse width responses of the LEDs.

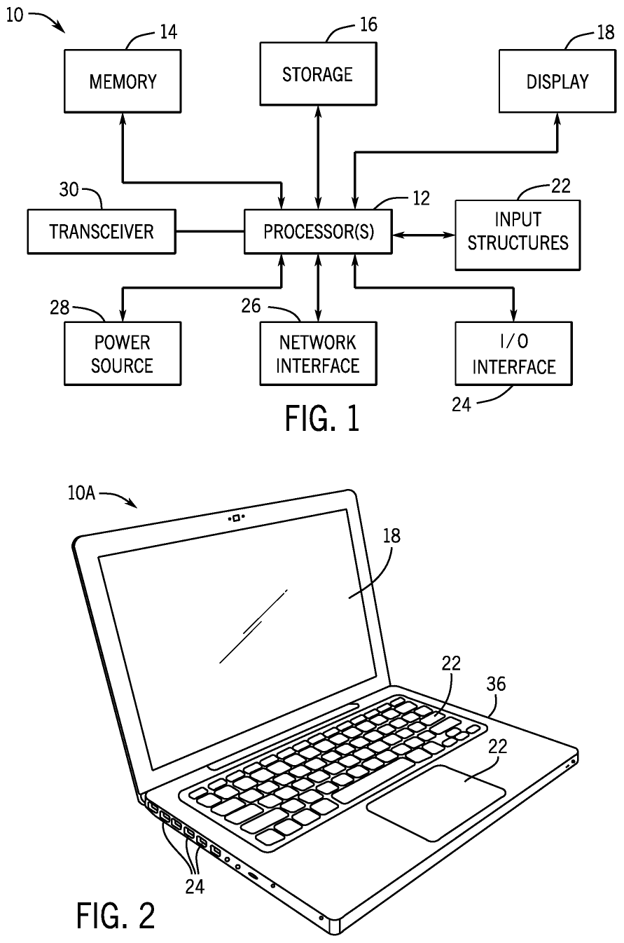

With the foregoing in mind, FIG. 1 illustrates an electronic device 10 according to an embodiment of the present disclosure may include, among other things, one or more processor(s) 12, memory 14, nonvolatile storage 16, a display 18, input structures 22, an input/output (I/O) interface 24, a network interface 26, a power source 28, and a transceiver 30. The various functional blocks shown in FIG. 1 may include hardware elements (including circuitry), software elements (including computer code stored on a computer-readable medium) or a combination of both hardware and software elements. It should be noted that FIG. 1 is merely one example of a particular implementation and is intended to illustrate the types of components that may be present in electronic device 10.

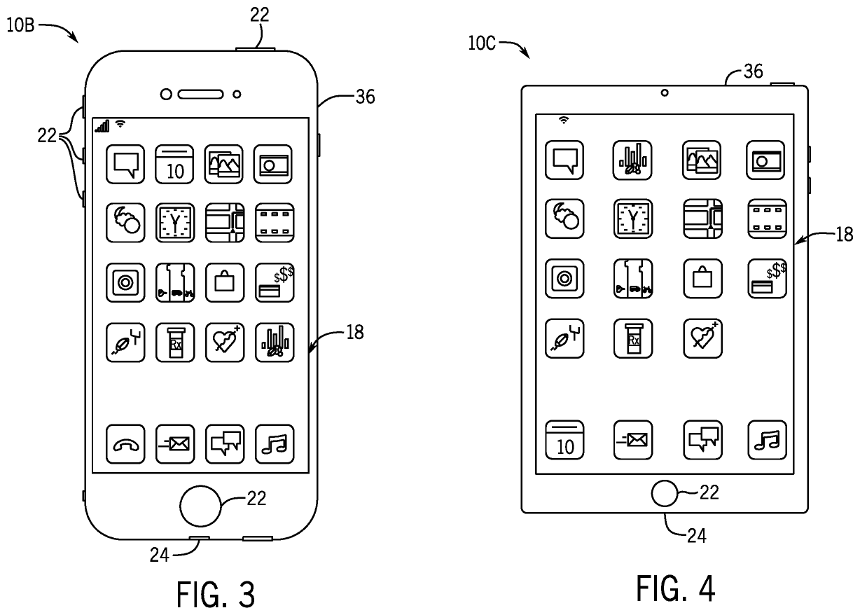

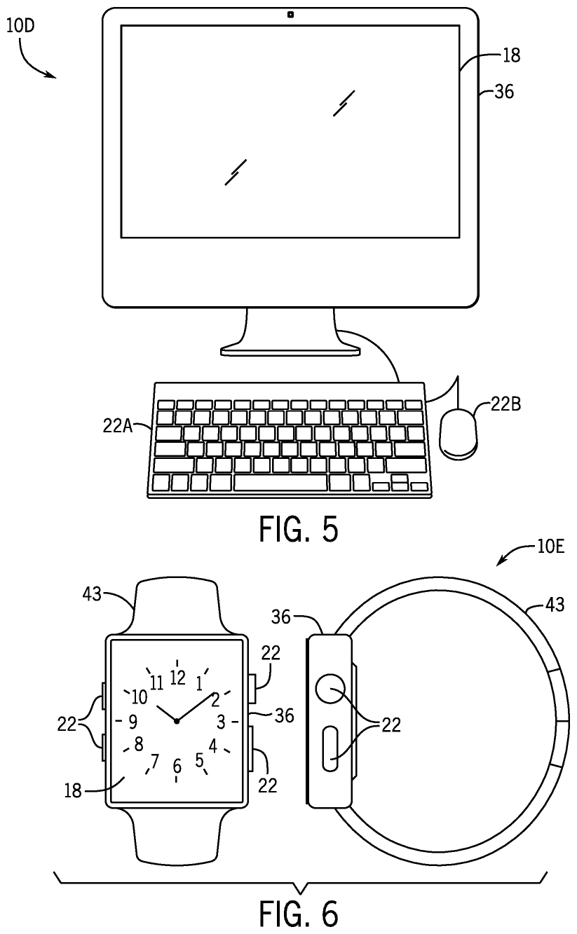

By way of example, the electronic device 10 may represent a block diagram of the notebook computer depicted in FIG. 2, the handheld device depicted in FIG. 3, the handheld device depicted in FIG. 4, the desktop computer depicted in FIG. 5, the wearable electronic device depicted in FIG. 6, or similar devices. It should be noted that the processor(s) 12 and other related items in FIG. 1 may be generally referred to herein as “data processing circuitry.” Such data processing circuitry may be embodied wholly or in part as software, hardware, or any combination thereof. Furthermore, the processor(s) 12 and other related items in FIG. 1 may be a single contained processing module or may be incorporated wholly or partially within any of the other elements within the electronic device 10.

In the electronic device 10 of FIG. 1, the processor(s) 12 may be operably coupled with a memory 14 and a nonvolatile storage 16 to perform various algorithms. For example, the algorithms may include ones for current-voltage driving (IV driving), current-voltage driving with active discharging of light emitting diodes (LEDs), current-voltage driving for LEDs having varying forward operating voltages, and so forth. Such algorithms or instructions executed by the processor(s) 12 may be stored in any suitable article of manufacture that includes one or more tangible, computer-readable media. The tangible, computer-readable media may include the memory 14 and/or the nonvolatile storage 16, individually or collectively, to store the algorithms or instructions. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor(s) 12 to enable the electronic device 10 to provide various functionalities.

In certain embodiments, the display 18 may be a liquid crystal display (LCD), which may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more light-emitting diode (LED) displays, organic light-emitting diode (OLED) displays, active-matrix organic light-emitting diode (AMOLED) displays, or some combination of these and/or other display technologies. In some instances, the display 18 may include LEDs that have non-uniform outputs due to, for example, different capacitance values. As will be described herein, to prevent the non-uniform outputs, the display 18 may use current-voltage driving for driving the LEDs of the display 18. Moreover, the display 18 a current-voltage circuit may include switches for actively discharging the LEDs and/or include the LEDs connected to higher voltage lines for LEDs having varying forward operating voltages. In this manner, current-voltage circuits may enable the LEDs to provide uniform luminance outputs, maintain the dynamic range, and/or reduce a current-resistance (IR) drop, of the display.

The input structures 22 of the electronic device 10 may enable a user to interact with the electronic device 10 (e.g., pressing a button to increase or decrease a volume level). The I/O interface 24 may enable the electronic device 10 to interface with various other electronic devices, as may the network interface 26. The network interface 26 may include, for example, one or more interfaces for a personal area network (PAN), such as a BLUETOOTH® network, for a local area network (LAN) or wireless local area network (WLAN), such as an 802.11x WI-FI® network, and/or for a wide area network (WAN), such as a 3^{rd} generation (3G) cellular network, universal mobile telecommunication system (UMTS), 4th generation (4G) cellular network, long term evolution (LTE®) cellular network, long term evolution license assisted access (LTE-LAA) cellular network, 5^{th} generation (5G) cellular network, and/or New Radio (NR) cellular network. In particular, the network interface 26 may include, for example, one or more interfaces for using a Release-15 cellular communication standard of the 5G specifications that include the millimeter wave (mmWave) frequency range (e.g., 24-300 GHz). The transceiver 30 of the electronic device 10, which includes the transmitter and the receiver, may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

In some embodiments, the electronic device 10 communicates over the aforementioned wireless networks (e.g., WI-FI®, WIMAX®, mobile WIMAX®, 4G, LTE®, 5G, and so forth) using the transceiver 30. The transceiver 30 may include circuitry useful in both wirelessly receiving the reception signals at the receiver and wirelessly transmitting the transmission signals from the transmitter (e.g., data signals, wireless data signals, wireless carrier signals, radio frequency signals). Indeed, in some embodiments, the transceiver 30 may include the transmitter and the receiver combined into a single unit, or, in other embodiments, the transceiver 30 may include the transmitter separate from the receiver. The transceiver 30 may transmit and receive radio frequency signals to support voice and/or data communication in wireless applications such as, for example, PAN networks (e.g., BLUETOOTH®), WLAN networks (e.g., 802.11x WI-FTC)), WAN networks (e.g., 3G, 4G, 5G, NR, and LTE® and LTE-LAA cellular networks), WIMAX® networks, mobile WIMAX® networks, ADSL and VDSL networks, DVB-T® and DVB-H® networks, UWB networks, and so forth. As further illustrated, the electronic device 10 may include the power source 28. The power source 28 may include any suitable source of power, such as a rechargeable lithium polymer (Li-poly) battery and/or an alternating current (AC) power converter.

The electronic device 10 may take the form of a computer, a portable electronic device, a wearable electronic device, or other type of electronic device. Such computers may be generally portable (such as laptop, notebook, and tablet computers), or generally used in one place (such as desktop computers, workstations, and/or servers). In certain embodiments, the electronic device 10 in the form of a computer may be a model of a MacBook®, MacBook® Pro, MacBook Air®, iMac®, Mac® mini, or Mac Pro® available from Apple Inc. of Cupertino, Calif. By way of example, the electronic device 10, taking the form of a notebook computer 10A, is illustrated in FIG. 2 in accordance with one embodiment of the present disclosure. The depicted notebook computer 10A may include a housing or enclosure 36, a display 18, input structures 22, and ports of an I/O interface 24. In one embodiment, the input structures 22 (such as a keyboard and/or touchpad) may be used to interact with the computer 10A, such as to start, control, or operate a graphical user interface (GUI) and/or applications running on computer 10A. For example, a keyboard and/or touchpad may allow a user to navigate a user interface and/or an application interface displayed on display 18.

FIG. 3 depicts a front view of a handheld device 10B, which represents one embodiment of the electronic device 10. The handheld device 10B may represent, for example, a portable phone, a media player, a personal data organizer, a handheld game platform, or any combination of such devices. By way of example, the handheld device 10B may be a model of an iPhone® available from Apple Inc. of Cupertino, Calif. The handheld device 10B may include an enclosure 36 to protect interior components from physical damage and/or to shield them from electromagnetic interference. The enclosure 36 may surround the display 18. The I/O interfaces 24 may open through the enclosure 36 and may include, for example, an I/O port for a hardwired connection for charging and/or content manipulation using a connector and protocol such as the Lightning connector provided by Apple Inc. of Cupertino, Calif., a universal serial bus (USB), or other similar connector and protocol.

The input structures 22, in combination with the display 18, may allow a user to control the handheld device 10B. For example, the input structures 22 may activate or deactivate the handheld device 10B, navigate user interface to a home screen, a user-configurable application screen, and/or activate a voice-recognition feature of the handheld device 10B. Other input structures 22 may provide volume control, or may toggle between vibrate and ring modes. The input structures 22 may also include a microphone that may obtain a user's voice for various voice-related features, and a speaker that may enable audio playback and/or certain phone capabilities. The input structures 22 may also include a headphone input that may provide a connection to external speakers and/or headphones.

FIG. 4 depicts a front view of another handheld device 10C, which represents another embodiment of the electronic device 10. The handheld device 10C may represent, for example, a tablet computer, or one of various portable computing devices. By way of example, the handheld device 10C may be a tablet-sized embodiment of the electronic device 10, which may be, for example, a model of an iPad® available from Apple Inc. of Cupertino, Calif.

Turning to FIG. 5, a computer 10D may represent another embodiment of the electronic device 10 of FIG. 1. The computer 10D may be any computer, such as a desktop computer, a server, or a notebook computer, but may also be a standalone media player or video gaming machine. By way of example, the computer 10D may be an iMac®, a MacBook®, or other similar device by Apple Inc. of Cupertino, Calif. It should be noted that the computer 10D may also represent a personal computer (PC) by another manufacturer. A similar enclosure 36 may be provided to protect and enclose internal components of the computer 10D, such as the display 18. In certain embodiments, a user of the computer 10D may interact with the computer 10D using various peripheral input structures 22, such as the keyboard 22A or mouse 22B (e.g., input structures 22), which may connect to the computer 10D.

Similarly, FIG. 6 depicts a wearable electronic device 10E representing another embodiment of the electronic device 10 of FIG. 1 that may be configured to operate using the techniques described herein. By way of example, the wearable electronic device 10E, which may include a wristband 23, may be an Apple Watch® by Apple Inc. of Cupertino, Calif. However, in other embodiments, the wearable electronic device 10E may include any wearable electronic device such as, for example, a wearable exercise monitoring device (e.g., pedometer, accelerometer, heart rate monitor), or other device by another manufacturer. The display 18 of the wearable electronic device 10E may include a touch screen display 18 (e.g., LCD, LED display, OLED display, active-matrix organic light emitting diode (AMOLED) display, and so forth), as well as input structures 22, which may allow users to interact with a user interface of the wearable electronic device 10E.

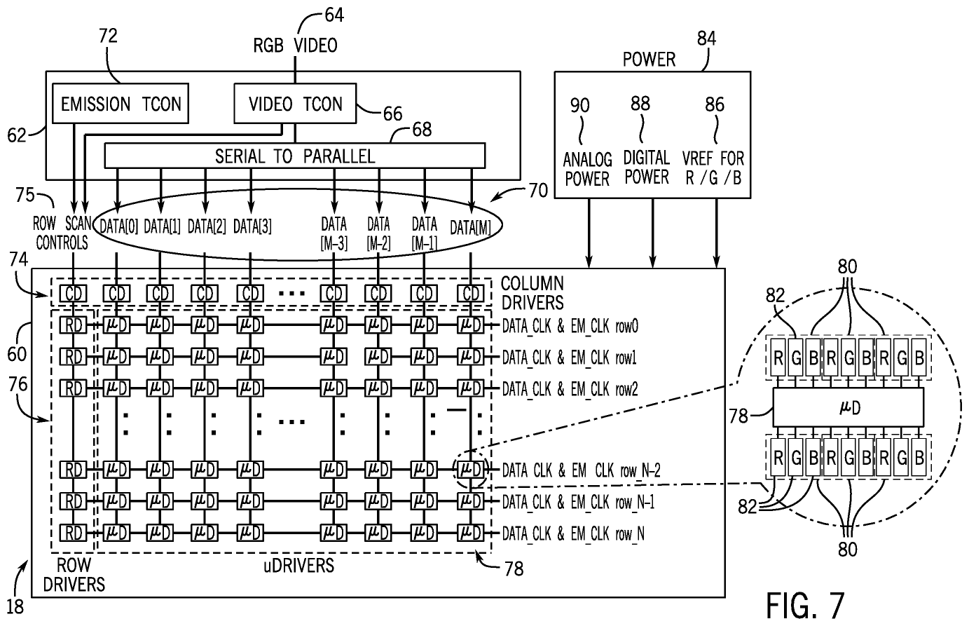

With the foregoing in mind, a block diagram of an architecture of a micro light emitting diode (μ-LED) display 18 appears in FIG. 7. Although the following descriptions describe μ-LEDs, the systems and methods described herein may apply to any suitable LED, such as μ-LEDs, mini LEDs, organic light emitted diodes (OLEDs), μ-OLED, and so forth. As shown, the display 18 may use a Red Green Blue (RGB) display panel 60 with pixels that include red, green, and blue μ-LEDs as subpixels. Support circuitry 62 may receive RGB-format video image data 64. It should be appreciated, however, that the display 18 may alternatively display other formats of image data, in which case the support circuitry 62 may receive image data of such different image format. In the support circuitry 62, a video timing controller (TCON) 66 may receive and use the image data 64 in a serial signal to determine a data clock signal (DATA_CLK) to control the provision of the image data 64 in the display 18. The video TCON 66 also passes the image data 64 to serial-to-parallel circuitry 68 that may deserialize the image data 64 signal into several parallel image data signals 70. That is, the serial-to-parallel circuitry 68 may collect the image data 64 into the particular data signals 70 that are passed on to specific columns among a total of M respective columns in the display panel 60. As such, the data 70 is labeled DATA[0], DATA[1], DATA[ ], DATA[3] DATA[M−3], DATA[M−2], DATA[M−1], and DATA[M]. The data 70 respectively contain image data corresponding to pixels in the first column, second column, third column, fourth column . . . fourth-to-last column, third-to-last column, second-to-last column, and last column, respectively. The data 70 may be collected into more or fewer columns depending on the number of columns that make up the display panel 60.

As noted above, the video TCON 66 may generate the data clock signal (DATA_CLK). An emission timing controller (TCON) 72 may generate an emission clock signal (EM_CLK). Collectively, these may be referred to as Row Scan Control signals. Circuitry on the display panel 60 may use the Row Scan Control signals to display the image data 70. Specifically, and as described herein, micro-drivers may use the emission clock to generate the pulse of emission to produce a luminance output at the subpixel (e.g., pulse when the clock goes high or to 1 and do not pulse when the clock goes to low or 0). Image data is received and stored based on the data clock signal (e.g., receive and store the image data when the clock goes high or to 1 and does not latch when the clock goes to low or 0).

The display panel 60 includes column drivers (CDs) 74, row drivers (RDs) 76, and micro-drivers (μDs) 78. In some embodiments, each μD 78 drives a number of pixels 80 having μ-LEDs as subpixels 82. Each pixel 80 includes at least one red μ-LED, at least one green μ-LED, and at least one blue μ-LED to represent the image data 64 in RGB format.

A power supply 84 may provide a reference voltage (V_{ref}) 86 to drive the μ-LEDs, a digital power signal 88, and an analog power signal 90. In some cases, the power supply 84 may provide more than one reference voltage (V_{ref}) 86 signal. Namely, in some embodiments, subpixels 82 of different colors may be driven using different reference voltages. As such, the power supply 84 may provide more than one reference voltage (V_{ref}) 86. Additionally or alternatively, other circuitry on the display panel 60 may step the reference voltage (V_{ref}) 86 up or down to obtain different reference voltages to drive different colors of μ-LED.

To allow the μDs 78 to drive the μ-LED subpixels 82 of the pixels 80, the column drivers (CDs) 74 and the row drivers (RDs) 76 may operate in concert. Each column driver (CD) 74 may drive the respective image data 70 signal for that column in a digital form. Meanwhile, each RD 76 may provide the data clock signal (DATA_CLK) and the emission clock signal (EM_CLK) at an appropriate to activate the row of μDs 78 driven by the RD 76. A row of μDs 78 may be activated when the RD 76 that controls that row sends the data clock signal (DATA_CLK). This may cause the now-activated μDs 78 of that row to receive and store the digital image data 70 signal that is driven by the column drivers (CDs) 74. The μDs 78 of that row then may drive the pixels 80 based on the stored digital image data 70 signal based on the emission clock signal (EM_CLK). That is, the μDs 78 may drive the pixels 80 for a duration corresponding to the pulse width generated by the emission clock signal (EM_CLK). However, as previously discussed, the pulse width driving the μ-LEDs and the μ-LED output luminance may be nonlinear (e.g., non-uniform output) due to long traces between the capacitors driving the μ-LEDs, a large number of μ-LEDs connected to the traces, and the like. In particular, the capacitors charging μ-LEDs associated with higher gray levels may take a relatively longer time to charge, and the higher capacitance may result in more nonlinearity. That is, a higher capacitance corresponds to a more non-uniform or nonlinear μ-LED output response (e.g., luminance). The non-uniformity may result in perceivable artifacts on the display 18.

In some instances, the non-uniformity across μ-LEDs, such as from the varying capacitance of the capacitors charging the μ-LEDs, may be corrected by applying a uniformity correction step prior to rendering images. In particular, the uniformity correction may include individually and independently scaling (e.g., extending or shortening) each of the pulse widths for driving each of the μ-LEDs. For example, the correction may include scaling up the pulse width for driving dimmer μ-LEDs emitting at lower gray levels, scaling down the pulse width for driving brighter μ-LEDs emitting at higher gray levels, or both. Specifically, the correction is based on a ratio of the deviation of the actual light response from the μ-LEDs to an average light response from the μ-LEDs. By way of example, the ratio between two LEDs or μ-LEDs measured over the same pulse widths may result in a 5% luminance difference change (e.g., 5 times brighter than the average light response), for both low and high capacitances. For the low capacitance, the ratio may remain constant or approximately constant for close to 99% of the entire duty cycle. However, for the high capacitance, the ratio may fluctuate and not be constant. Moreover, the ratio changes may be most noticeable at relatively high gray levels, where the non-uniformity is perceivable on the display 18. These gray levels may be any gray levels above a threshold at which the human eye may perceive image errors due to the capacitance. By way of example, an 8-bit gray level may have 256 distinct steps (gray level 0 to gray level 255) or a 9-bit gray level may have 512 distinct steps (gray level 0 to gray level 511). In certain higher gray levels, which may be measured experimentally, the capacitance could result in image artifacts.

To reduce or eliminate such image artifacts, the display 18 may provide a constant charge per unit time to the μ-LEDs so that the actual response is the same or approximately the same as the average response (e.g., ratio of 1 or approximately 1). The display 18 may do so using current (I) and voltage (V) driving (IV driving or current-voltage driving) for the μ-LEDs. In particular, IV driving may involve the charging of the parasitic capacitors from a voltage source with a value approximately the same as the operating voltage at the beginning of the emission pulse to charge the μ-LEDs (e.g., a pre-charging period), prior to providing the charge per unit time from a current source. That is, at the rising edge of the first emission clock, the μ-LEDs may first be driven using the voltage source (e.g., for an arbitrarily short drive time) and subsequently be switched to being driven using a current source. That is, the switching occurs at a rising edge of an emission clock corresponding to a gray level. The gray level may include the top quarter (e.g., highest quarter) of the gray level range for an N-bit-deep image (e.g., N-bit-depth image), where N is 1 or more, and the gray level range is 2 to the power of the N-bit-deep image (2^{N}). For example, for an 8-bit deep image, the gray level range may include 0 to 255 gray levels (e.g., 2⁸=256 gray levels and 0 is the lowest gray level, 2⁹=512 gray levels, and so forth).

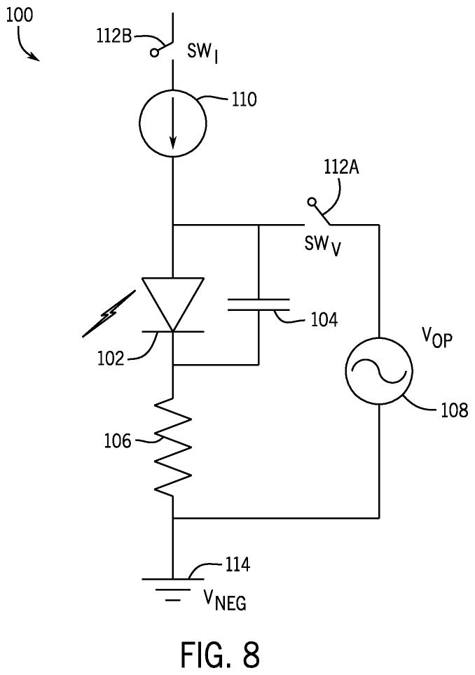

To illustrate, FIG. 8 is a schematic diagram of a current-voltage circuit 100 for IV driving. The current-voltage circuit 100 includes an LED 102 (e.g., μ-LED), a parasitic capacitor 104 (e.g., a load capacitance, which is always present on the panel), a resistive element 106 (e.g., a resistor or a conductor having a resistance), an operating voltage source 108, a current source 110, a voltage source switch 112A, and a current source switch 112B. Although the following descriptions describe a single LED, the current-voltage circuit 100 of the display panel may include multiple LEDs 102 (e.g., ten, one hundred, thousand, and so forth). Moreover, any suitable device that may control the electronic device 10 and/or the isolation circuitry 58, such as pixel driving circuitry, state machine circuitry, and/or the processor(s) 12 (e.g., one or more processors), may perform a method or process associated with the circuits of FIGS. 8-16. By way of example and in some embodiments, the method or process described with respect the circuits of FIG. 8-16 may be implemented by executing instructions stored in a tangible, non-transitory or non-volatile, computer-readable medium, such as the memory 14 (e.g., one or more memory devices), using the processor(s) 12. The processor(s) 12 of the electronic device 10 may execute instructions to perform the method that are stored in the memory 14 and carried out by the processor(s) 12. As another example, the pixel driving circuitry may turn on (e.g., close switches) or turn off (e.g., open switches), cause signals to emit (e.g., cause an emission pulse signal to pulse), and the like. Although the systems and methods described herein include the pixel driving circuitry as performing the processes or processor-executable methods, which represents a particular embodiment, the system and methods described herein may additionally or alternatively be performed by other data processing circuitry of the display 18. The method or process may be described using steps in a specific sequence, however, it should be understood that the present disclosure contemplates that the described steps may be performed in different sequences than the sequence described, and certain described steps may be skipped or not performed altogether.

In the current-voltage circuit 100, the parasitic capacitor 104 may provide the charge to the LED 102 to emit at a particular brightness level. For example, the capacitor 104 may discharge through the LED 102 during a voltage drive time of current-voltage driving. The parasitic capacitor 104 may discharge through the LED 102 up to the operating voltage (e.g., an illumination threshold), which corresponds to the voltage to emit at the gray level to be emitted by the LED 102. As will be discussed herein, the operating voltage source 108 may additionally provide the charge for charging the LED 102 and the capacitor 104 to the LED operating voltage. The operating voltage source 108 may charge the LED 102 faster than the current source 110 that may provide the charge for the LED 102. That is, the operating voltage source 108 may provide a large amount of charge in a shorter amount of time than the current source 110. In particular, the current source 110 may provide a constant charge per unit and take a relatively longer time to charge the LED 102 along with the parasitic capacitor 104 to reach the operating voltage of the LED 102 to starting emitting light. Without using the operating voltage source 108 to quickly charge the LED 102 and the parasitic capacitor 104 (e.g., only use the current source 110), the LED 102 may not emit light, resulting in a limited the total available pulse width, and thus, a reduced total dynamic range.

The illumination threshold may include a range of luminesce up to illumination at the particular gray level. The resistive element 106 may reduce the current that flows through it to reduce brightness emitted from the LED 102. For example, the resistive element 106 may function to reduce current to dim the LED 102 from emitting at a present gray level (e.g., to provide a subsequent darker image on the display 18). The negative voltage 114 is grounded and may receive negative voltage from a power supply, such as the operating voltage source 108. In general, the LED 102 may turn on at a turn-on voltage, which is the voltage that causes the LED 102 to turn on or starting using charge (e.g., from the operating voltage source 108 and/or the parasitic capacitor 104. In some embodiments, the LED 102 may use the charge (e.g., from the operating voltage source 108) until the LED 102 approximately reaches the operating voltage to emit at the desired brightness corresponding to a particular gray level. As will be discussed herein, the LED 102 may switch to using charge from a current source upon approximately reaching the operating voltage. The turn-on voltage may be a voltage difference across the LED 102. Different brightness levels may have different voltage drops across the respective emitting LEDs and as such, may correspond to different turn-on voltages.

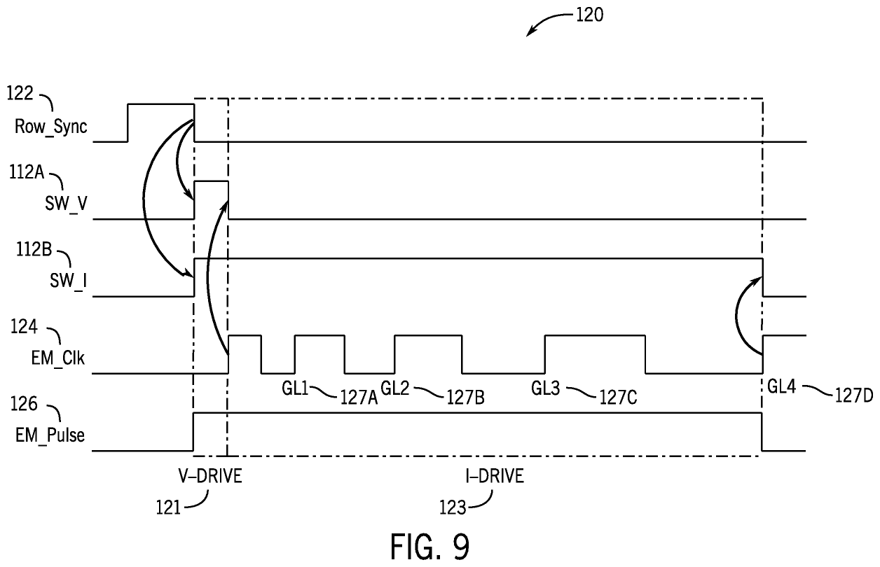

As will be described with respect to FIG. 9, the operating voltage source 108 may charge the capacitor 104 during a voltage drive time of an emission pulse. During a voltage drive time, the voltage source switch 112A may be closed (e.g., on), connecting the operating voltage source 108 to the LED 102. The capacitor 104 may receive the charge from the operating voltage source 108 during the voltage drive time. The LED 102 may be disconnected from the voltage source 108 (e.g., by opening the voltage source switch 112A) and switch have only the current source 110 for receiving the constant charge per unit time. Switch 112B is closed at the beginning of emission at the same time as switch 112A. The voltage source 108 may be disconnected at some point immediately or approximately immediately before illumination (e.g., reaching the operating voltage to emit at the desired brightness level) and then the current source 110 may provide the charge per unit time to the LED 102. As a consequence, the current source 110 may cause the one or more light emitting diodes to emit light uninterrupted or approximately uninterrupted (e.g., substantially uninterrupted) when changing between voltage drive to current drive due to the charge stored in the capacitor 104.

To illustrate the voltage drive time and the current drive time, FIG. 9 is a timing diagram 120 corresponding to the current-voltage circuit of FIG. 8. In some embodiments, the processes described herein of FIGS. 8-16 may be performed by pixel driving circuitry. For example, the circuitry may count the falling edges of an emission clock and compare them to a particular gray level (e.g., stopping when total falling edges corresponds to the particular gray level). As shown, the timing diagram 120 includes a row synchronization signal 122 (Row_Sync), an emission clock 124 (EM_Clk), an emission pulse signal 126 (EM_Pulse), the voltage source switch 112A (SW_V), and the current source switch 112B (SW_I). The row synchronization signal 122 may synchronize one or more rows of the μDs 78 and LEDs 102 of the display 18. That is, the row synchronization signal 122 may enable the rows of μDs 78 to be ready for configuring at the same or approximately the same time, for example, by receiving other signals. After the rows of μDs 78 are synchronized and ready to receive data, at the falling edge of the row synchronization signal 122, the voltage source switch 112A and the current source switch 112B may be turned on or closed (e.g., at a logic 1, the rising edge). In particular, the voltage source switch 112A may be turned on for a short duration of the voltage drive time (e.g., the pre-charge time). The current source switch 112B may also be turned on (e.g., closed).

The emission pulse signal 126 may enable pixel driving circuitry (not shown) through the switch 112B for the LED 102 (e.g., LEDs 102 driven by the μDs 78 in each of the activated rows) to drive current to the LED 102. Specifically, when the emission pulse signal 126 is on (e.g., logic 1 or at the rising edge), causing light to emit from the selected LED 102. On the other hand, the emission pulse signal 126 may disable the pixel driving circuitry for the LED 102 when the emission pulse signal 126 is off (e.g., logic 0 or at the falling edge). The longer the selected LED 102 is driven based on the emission pulse signal 126, the greater the amount of light is emitted (e.g., higher brightness) from the LED 102. The emission clock signal 124 may control how long the emission pulse signal 126 is on for the LED 102. In some embodiments, and as depicted, the emission clock signal 124 may be nonlinear (e.g., pulses may have progressively longer duration or a shorter duration), for example, based on the brightness or continuing brightness level to be emitted by the LED 102. The emission clock signal 124 is shown to have pulses that grow nonlinearly longer (e.g., exponentially longer) as gray levels increase. This may correspond to a gamma conversion of the linear gray levels to nonlinear light emission based on principles of human visual perception.

During a voltage drive time 121, the operating voltage source 108 may drive the LED 102 (e.g., charge the capacitor 104 that charges the LED 102) up until LED 102 has approximately reached its operating voltage (e.g., desired brightness corresponding to a gray level). As shown, upon almost reaching the operating voltage, the pixel driving circuitry (e.g., display control circuitry, state machine circuitry, support circuitry 62, and the like) may switch to charging the LED 102 using the current source 110. Specifically, upon almost reaching the operating voltage, the pixel driving circuitry of the display panel 18 may turn off the voltage source switch 112A (e.g., logic 0 or at the falling edge). As such, pixel driving circuitry may switch to a current drive time 123 to drive the LED 102 with the current source 110 (e.g., of FIG. 8) since the current source 110 is also enabled by the current source switch 112B. Since the LED 102 is already almost at the operating voltage from the voltage drive time 121, the current source 110 may provide a constant current. The current source 110 may continue to provide the constant current to the LED to cause the LED to emit light until an edge of the emission clock 124 is reached that corresponds to the current gray level. For example, when the gray level of the image data to be represented by an LED is a fourth gray level (GL 4), the EM pulse signal 126 may continue as edges corresponding to a first gray level 127A (GL 1), a second gray level 127B (GL 2), and a third gray level 127C (GL 3), until the fourth gray level 127D (GL 4) edge is reached. This may cause the current source switch 112B to be switched off (e.g., logic 0 or falling edge).

However, in some embodiments, after the voltage source 108 has finished charging the LED 102 (e.g., when the voltage level approximately corresponds to the operating voltage), the LED 102 may start illuminating. That is, the pixel driving circuitry may disconnect the voltage source 108 and enable the LED 102 to use the charge provided by the voltage source 108 to pass through the LED 102. As the charge passes through the LED 102, the LED 102 may unexpectedly illuminate or illuminate at an unexpected brightness level.

Typically, the brightness to be emitted by the LED 102 for the gray level of 0 is zero. To ensure there is no unexpected luminance or glow, the capacitor 104 may not be charged up, and that may be controlled by digital logic in the μD 78, which may control and prevent switch 112A from turning on. For gray levels above 0, in which the LED 102 will emit light, the LED 102 may rapidly charge up using the charge provided by the operating voltage source 108 before switching to receiving a steady flow of charge to emit light using the current source 110. The voltage source 108 may be disconnected right before illumination (e.g., an illumination threshold), and then the current source 110 may keep providing the LED 102 with current. Using low voltages may result in the voltage being below the turn on voltage. On the other hand, using a high operating voltage during the voltage drive time 121 of the IV driving could create a visible floor for luminance output (e.g., luminance floor.

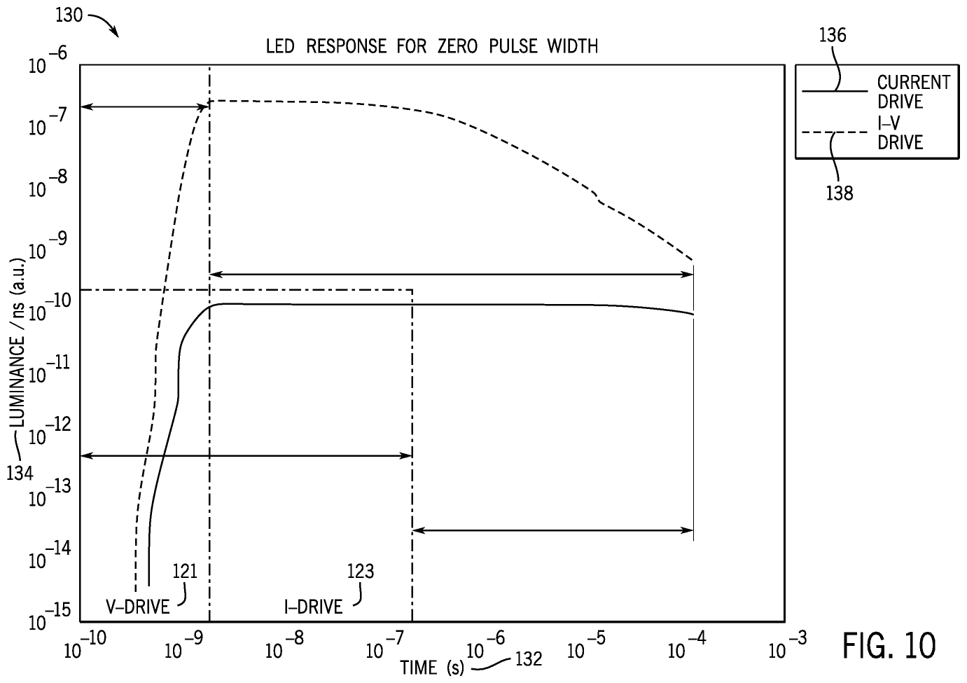

To illustrate, FIG. 10 is a graph 130 having an x-axis of time 132 in seconds (s) and a y-axis of luminance per nanosecond (ns) 134 (luminance/ns). In particular, the graph 130 illustrates nits (e.g., a unit of measurement for the total brightness over one square meter of the display 18) floor for IV driving 138, indicated by a dashed line, and current driving 136 (I driving), indicated by a solid line. The IV driving 138 may facilitate operating at higher potential that facilitates charging up anodes of the LEDs 102 faster than driving LEDs 102 without IV driving 138. However, IV driving 138 may also facilitate operating at the higher potential for a shorter time during a voltage drive time 121. Moreover, the anodes may not be charged to the high potential during the current drive time 123, and may take a longer time to charge up during a portion of a current drive time 123 (as indicated by the dashed line box). As shown, the lowest light emission in units of nits that may result from IV driving 138 is much higher than the current driving 136 due to the capacitance of the LED 102 being charged to a higher operating voltage. The discharge from the IV driving 138 after the current source switch 112B is turned off may produce light, which is the nits floor of the system.

On the other hand, the current driving 136 may produce little or no discharge through the LED 102 since the pre-charge voltage (e.g., charging via the operating voltage source 108 during the voltage drive time 121) is lower than the LED turn-on voltage. As such, the discharge from current driving 136 may not produce visible light. The higher nits floor with IV driving 138 could reduce the dynamic range of the display 18. Moreover, the nits floor may directly correspond to the LED 102 and trace capacitance. In some embodiments, the nits floor may additionally or alternatively be attributable to external quantum efficiency (EQE) and IV response. That is, as the load and parasitic capacitance increases, the nits floor increases. The dynamic range of the system is therefore sensitive to capacitance. To reduce or prevent a high nits floor that may result from IV driving 138, such as by charging the capacitor 104 with a high voltage (e.g., instead of a low voltage), the capacitance of the LED 102 may be actively discharged at the end of the emission pulse.

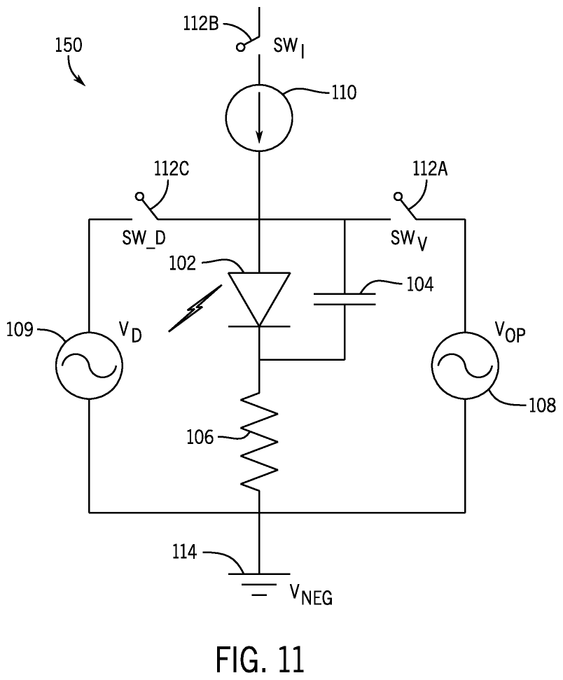

To illustrate, FIG. 11 is schematic diagram of a current-voltage circuit 150 with discharging switches for actively discharging LEDs 102. The current-voltage circuit 150 includes the LED 102, the capacitor 104, the resistive element 106 the operating voltage source 108, the current source 110, the voltage source switch 112A, the current source switch 112B, and the negative voltage rail 114. These components may function and operate similarly as described with respect to FIG. 8. The current-voltage circuit 150 also includes a voltage source 109 also known as the reset voltage source and a discharge switch 112C.

At the end of an emission pulse signal 126 for the LED 102 (e.g., each of the LEDs 102), the pixel driving circuitry may switch the discharge switch 112C to on (e.g., close switch). Turning on the discharge switch 112C may discharge the capacitor 104 at a potential below the turn-on voltage of the LED 102. That is, immediately after the voltage drive time 121 is complete, the pixel driving circuitry may switch the anode of the LED 102 to a potential below turn on by discharging the charge stored in the LED 102 (e.g., μLED) as well as capacitor 104 to the cathode. The discharge should pass through the switch 112C instead of the LED 102, which would otherwise generate light. Actively discharging the LED 102 after emission may lower the nits floor for IV driving 138. In this manner, the active discharge may reduce or prevent a decrease to the dynamic range of the display panel 18.

However, charging and subsequently discharging the capacitance via the active discharge may result in power trade off. The power trade off may be based on frequency. Moreover, the power trade off may be equal to or approximately equal to the capacitance of the LED 102 multiplied by the difference of the below turn-on voltage and the operating voltage of the LED (e.g., Vop). For example, the faster the capacitor is charged and discharged (the frequency of doing charging and discharging), the more power is consumed.

Generally, the active discharge may have a greater impact for lower gray levels (e.g., dim luminance). In particular, without the active discharge, the charge stored in the capacitor 104 would discharge through the LED 102 and produce light. However, with the active discharge, the capacitor 104 may discharge the charge to the power supply without generating any light. At high gray levels (e.g., gray levels corresponding to a time period in which the discharge time for the current drive time 123 is less than or approximately less than half of the total discharge time required for the gray level), without active discharge, the time for the capacitor 104 to discharge through the LED 102 before the using the switches 112 may be limited, resulting in an output similar to the light output with active discharge. The impact of the extra power consumption may be reduced or mitigated by turning off active discharge for higher gray level settings, in which the nits floor is relatively less significant.

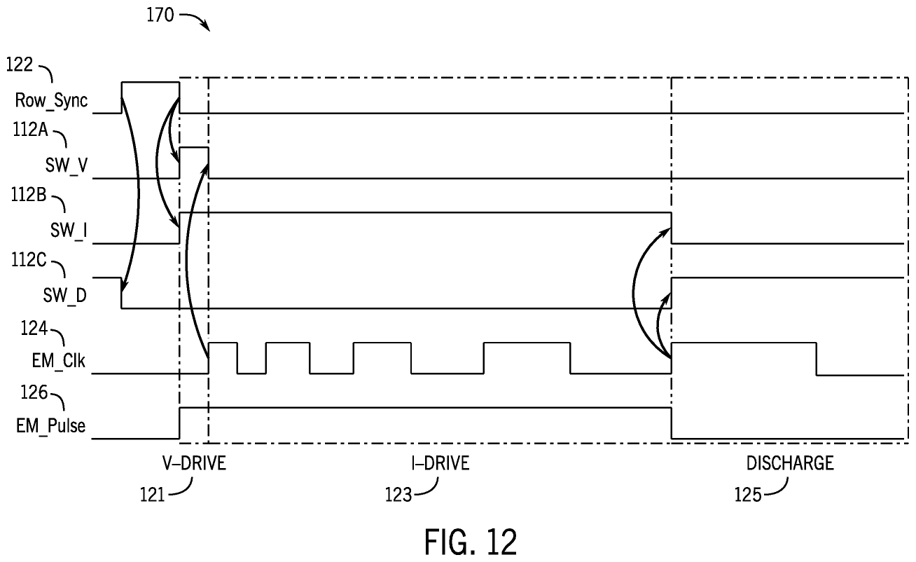

FIG. 12 is a timing diagram 170 corresponding to the current-voltage circuit 150 with the discharging switch 112C of FIG. 8. As shown, the timing diagram 170 includes a row synchronization signal 122 (Row_Sync), an emission clock 124 (EM_Clk), an emission pulse 126 (EM_Pulse), the voltage source switch 112A (SW_V), and the current switch 112B (SW_I). These signals may function as described with respect to FIG. 9. The timing diagram also includes a signal for the discharge switch 112C. As shown, the discharge switch 112C (SW_D) may be initially turned off or in a closed position (e.g., logic 1 or rising edge). As the row synchronization signal 122 is turned on (e.g., logic 1 or rising edge), the discharge switch 112C may be turned off or in an open position (e.g., logic 0 or falling edge). After the rows of μDs 78 are synchronized and ready to receive data, at the falling edge of the row synchronization signal 122, the voltage source switch 112A and the current switch 112B may be turned on or closed (e.g., at a logic 1 or the rising edge). In particular, the voltage source switch 112A may be turned on for a short duration of the total emission time. The current switch 112B may also be turned on. The emission pulse signal 126 may enable driving circuitry (not shown) for the LED 102 (e.g., LEDs 102 driven by the μDs 78 in each of the activated rows) to drive the LED 102, as discussed with respect to FIG. 9.

After the emission pulse, the LED 102 may enter a discharge time 125, in which the discharge switch 112C may be turned on (e.g., logic 1) to discharge an anode of the LED as well as the parasitic capacitor 104 to the turn-on voltage or below the turn-on voltage of the LED 102. As previously mentioned, actively discharging the LED 102 after emission may lower the nits floor for IV driving 138. In this manner, the active discharge may reduce or prevent a decrease to the dynamic range of the display panel 18.

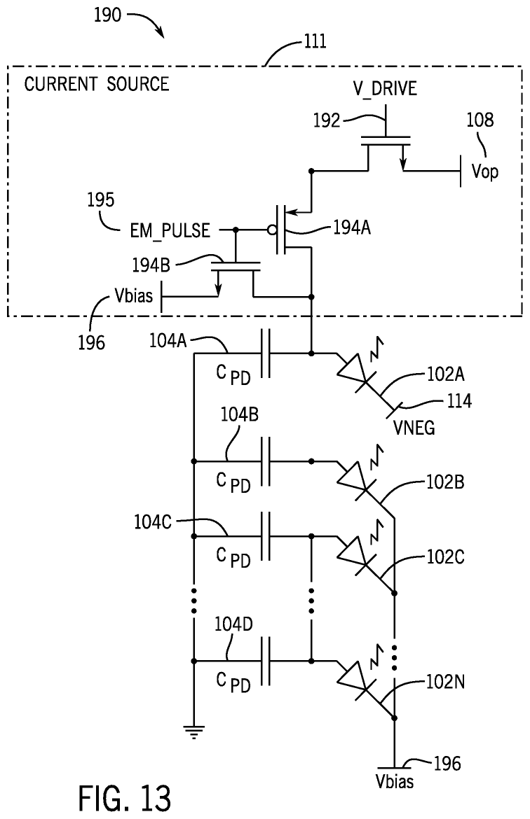

FIG. 13 is a schematic diagram of a current-voltage circuit 190 for driving LEDs 102 of a display 18 at different times of a frame. As shown, the current-voltage circuit 190 includes a voltage drive transistor 192 (V_drive), a power supply voltage source 111 (ELVDD), an operating voltage source 108 (Vₒₚ), a p-channel metal-oxide-semiconductor (PMOS) transistor 194A, a n-channel metal-oxide-semiconductor (NMOS) transistor 194B, an emission pulse transistor 195 (EM_Pulse), a voltage bias source 196 (v_{biad}), a negative voltage 114 (V_{neg}), multiple LEDs 102, and multiple passive display capacitors (C_{PD}) 104. In particular, the LEDs 102 may include a first LED 102A, a second LED 102B, a third LED 102C, up to N LEDs 102N, in which N may include one or more LEDs 102 (e.g., one, ten, hundred, and so forth). Each of the LEDs 102 may be charged by a respective capacitor 104A, such as a first capacitor 104A (e.g., that charges the first LED 102A), a second capacitor 104B, a third capacitor 104C, an Nth capacitor 104D, and so forth.

Generally, the voltage drive transistor 192, the operating voltage source 108, the PMOS transistor 194A, the NMOS transistor 194B, the emission pulse transistor 195, and the voltage bias source 196 may connect to the current source 110, which charges each of the LEDs 102. The voltage drive transistor 192 may be used during the voltage drive time 121 to pre-charge the LEDs 102, as previously discussed. The current source may be used during the current drive time 123, as well as drive the LEDs 102 at different, non-overlapping times of a frame.

By way of example, to drive eight LEDs 102, the current source 110 may drive each of the LEDs 102 for ⅛ of the total time of the frame (e.g., ⅛ each for a 60 Hz frame). The current source may drive the LEDs 102 parallel. The operating voltage source 108 may function as discussed with respect to FIG. 11 and FIG. 12. The operating voltage source 108 may connect to the LEDs 102 and the capacitors 104. The voltage drive transistor 192 may operate as an active switch connected to the operating voltage source 108, and the operating voltage source 108 may charge the LEDs 102 during the voltage drive time 121, as previously discussed. The emission pulse may control how long the LEDs 102 may be on, and thus, the emission pulse transistor 195 may be closed or on (e.g., logic 1) for an entire operation.

The PMOS transistor 194A and the NMOS transistor 194B are complementary pairs. That is, when the emission pulse is set to a logic low (e.g., logic 0), the PMOS transistor 194A will be on and the NMOS transistor 194B will be off. On the other hand, when the emission pulse is set to a logic high (e.g., logic 1), the PMOS transistor 194A will be turned on and the NMOS transistor 194B will be turned off. The complementary pair of the PMOS transistor 194A and the NMOS transistor 194B may connect to the LEDs 102, such as to anodes (e.g., positive terminal) of the LEDs 102 and charge using the operating voltage source 108 when the voltage drive transistor is 192 on. If voltage drive transistor is 192 is off, then the current source 110 may provide the charge to the LEDs 102.

The bias voltage source 196 may be set to a voltage to turn on respective LEDs 102. To charge particular LEDs 102 (e.g., one or a portion of the LEDs 102), the cathodes (e.g., negative terminal) of the particular LED(s) 102 may be set to a low potential using any suitable switches (not shown). The resulting path with least resistance to the LEDs 102 may provide the charge to the lowest potential while the LEDs 102 set to a higher potential may not carry the current. Thus, the current-voltage circuit 190 enables selectively driving the LEDs 102 via the bias voltage source. In some embodiments, the LEDs 102 may be charged in one or more phases. That is, the LEDs 102 (e.g., a set of LEDs) connected to the current-voltage circuit 190 (e.g., via a phase switch) may be charged for a first phase (e.g., pre-charge voltage drive time) and then the LEDs 102 connected to the current-voltage circuit 190 may be charged for a second phase (e.g., the same LEDs 102 charged during a current drive time or a different set of LEDs 102 charged during the voltage drive time).

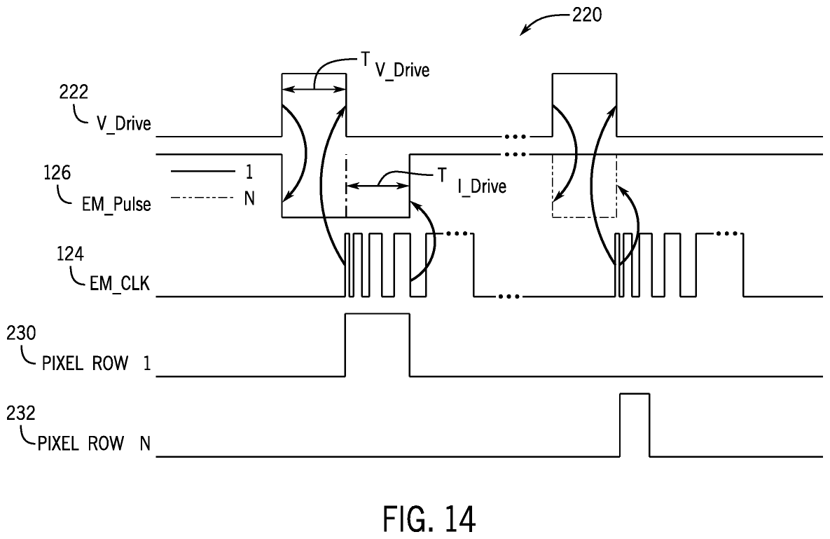

FIG. 14 is a timing diagram 220 corresponding to the current-voltage circuit implemented in the display 18 of FIG. 13. The timing diagram 220 illustrates a voltage drive signal 222 for the voltage drive transistor 192, an emission pulse signal 126 for the emission pulse transistor 195, an emission clock signal 124, a first pixel row 230 (row 1), and an N pixel row 232 (row N).

When the voltage drive signal 222 is on (e.g., logic 1), the voltage drive signal 222 enables the operating voltage (e.g., the operating voltage source 108 of FIG. 13) to charge the LEDs 102 while the emission pulse signal 126 is on (e.g., logic 1). During this time, the LEDs 102 may be charged but the LEDs 102 may not emit light. The voltage drive signal 222 turns off (e.g., logic 0 or falling edge) signifying the onset of the emission clock signal 124. That is, the emission pulse signal 126 starts counting during the first pixel emission period (e.g., LED 102), as defined by the emission non-linear clock signal 124. At that time, one or more pixels of the first pixel row 230 may emit light. Pixels of the first pixel row 230 may be connected to the negative voltage 114 (e.g., used to turn on pixels or LEDs 102) while pixels of non-selected rows may be connected to the bias voltage 196 (e.g., of FIG. 13). Similarly, for one or more pixel of an N pixel row (pixel row N, where N is one or more), as a second pulse of the voltage drive signal 222 turns off (e.g., logic 0 or falling edge) and as the emission clock signal 124 turns on, the emission pulse signal 126 starts to count pulses for an Nth pixel. At that time, one or more pixels of the N pixel row 232 may emit light. Pixels of the N pixel row 232 may be connected to the negative voltage 114 (e.g., used to turn on pixels or LEDs 102).

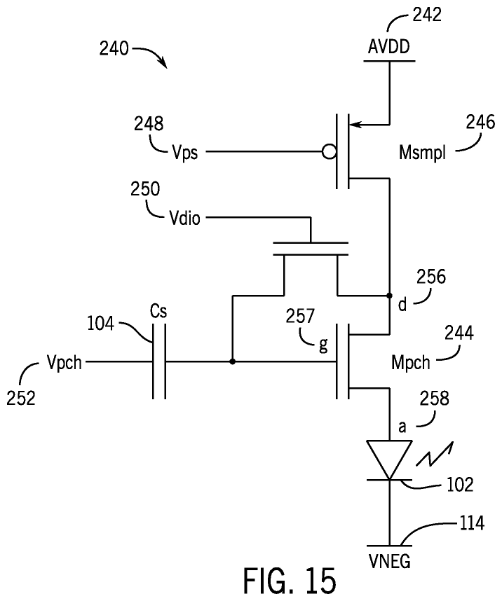

FIG. 15 is a schematic diagram of the current-voltage Vop-buffer circuit 240 for light emitting diodes having varying forward operating voltages. Generally, the current-voltage circuit 240 may provide a common potential across the LEDs 102 of the display panel 18 during the voltage drive time 121. However, the forward operating voltage of the LEDs 102 may vary due to process variations. Additionally, voltage drops appearing on the cathode routing of the LEDs 102 may also restrict voltage applied on the LEDs 102 during the voltage drive time 121 of the IV driving 138. As such, the LEDs may not start the current drive time 123 of the IV driving 138 from the ideal forward-biased potential. In particular, LED depletion and quantum well capacitors may charge slowly by a current source 110 until the LEDs 102 reach the respective ideal operating forward voltage, effectively reintroducing some sensitivity to capacitance variations.

The current-voltage Vop-buffer circuit 240 reduces the effects of the LEDs 102 forward voltage (Vf) variation as well as any variations in cathode potential of a cathode of the LED 102 during the voltage drive time 121. In particular, a pre-charge potential applied to the LEDs 102 may come from a voltage follower topology that connects to a higher voltage line while the voltage drive time 121 is divided into multiple time slots, in which voltage characteristics of the LED 102 may be sampled and subsequently applied to the gate of a pre-charge transistor. The current-voltage circuit 240 may include an analog positive supply 242 (AVDD), a pre-charge transistor 244 (Mpch), a sampling transistor 246 (Msmpl), a sample voltage 248 (Vps), a diode voltage 250 (Vdio), a pre-charge voltage 252, a storage capacitor 104 (Cs), an LED 102, and a negative voltage 114 (Vneg).

In the current-voltage circuit 240, the pre-charge potential applied to the LEDs 102 may be provided from a voltage follower topology that connects to a higher voltage line, including an analog positive supply 242 (AVDD) and a pre-charge transistor 244, while the voltage driving portion of IV driving 138 is divided into multiple smaller time slots, as previously mentioned. The pre-charge voltage 252 potential may be set to a low potential V_{low} and the diode voltage 250 may also be set to a particular voltage. The storage capacitor 104 may initially store a voltage of the difference between the analog positive supply 242 and the low potential (AVDD-V_{low}).

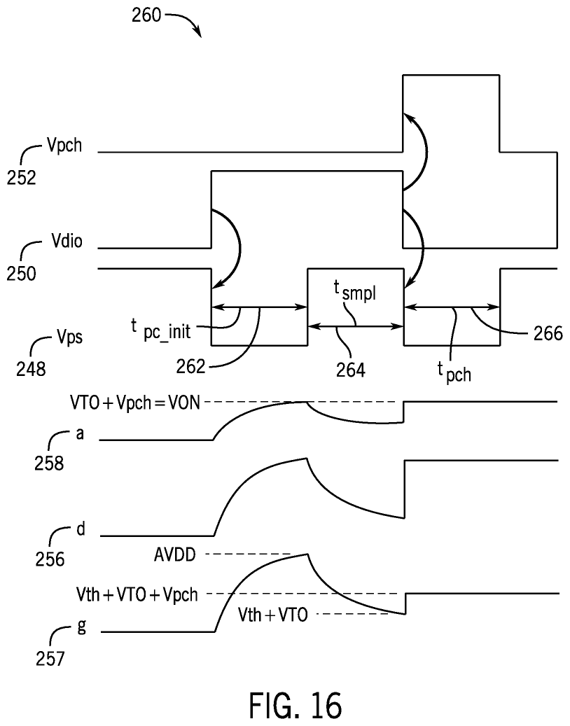

As previously mentioned, the voltage drive time 121 may be divided into multiple time slots, in which voltage characteristics of the LED 102 may be sampled and subsequently applied to the gate of a pre-charge transistor 244. As shown with respect to FIG. 16, the multiple time slots may include an initial pre-charge period 262 (t_{pc_init}), a sampling period 264 (tₛₘₚₗ), and a pre-charge period 266 (t_{pch}). Generally, FIG. 16 illustrates a timing diagram 260 corresponding to the current-voltage circuit 240 for the light emitting diodes having varying forward operating voltages of FIG. 15. Referring back to FIG. 15, the diode voltage 250 may remain set but sampling voltage 248 may turn off the sampling transistor 246, resulting in a floating node at the drain 256 (d) of the pre-charge transistor 244. At this time, node d may discharge through the pre-charge transistor 244 and the LED 102 until a voltage at the anode 258 (a) of the pre-charge transistor 244 causes the pre-charge transistor 244 into a deep subthreshold and eventually turning it off.

As illustrated in FIG. 16, the potential at node d 256 may be a sum of a threshold voltage (Vₜₕ) (e.g., lowest gate-to-source voltage that enables the respective transistor to operate, such as AVDD-Vₜₕ-V_{TO}, as shown at a gate node 257 (g)) and the turn-on voltage (V_{TO}) (e.g., (Vₜₕ+V_{TO})) and is stored in the storage capacitor 104. Furthermore, the diode voltage 250 may turn off at the same time or approximately the same time as sampling voltage 248, which turns on the sampling transistor 246 (e.g., of FIG. 15). The pre-charge voltage 252 is pulsed to a preset pre-charge voltage. Additionally, a voltage potential of a node g 257 of the pre-charge transistor 244 is the sum of the threshold voltage, turn-on voltage, and a pre-charge voltage (Vₜₕ+V_{TO}+V_{pch}). By way of example, the voltage potential may be the turn on voltage of the LEDs 102, and the turn on voltage may depend on color and LED type, such as LEDs, μLEDs, OLED, μLED, and so forth (e.g., a voltage greater than 0V that causes the LED to turn on, sometimes between 3V and 5 V, such as approximately 4V). As such, using the systems and methods described herein, IV driving 138 with active discharging, driving of selective LEDs, and/or applying a pre-charge potential to LEDs from a voltage follower topology that connects to higher voltage lines, reduces or prevents effects of capacitance of LEDs on pulse width responses.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

1. A display device, comprising:
a voltage source configured to provide a voltage;
a current source configured to provide a current;
one or more light emitting diodes configured to emit light to facilitate displaying an image on the display device; and
pixel driving circuitry configured to drive the one or more light emitting diodes using the voltage or the current at least in part by:
providing the one or more light emitting diodes with the voltage from the voltage source for a first period of time to enable the one or more light emitting diodes to reach an illumination threshold; and
after providing the voltage from the voltage source for the first period of time, driving the one or more light emitting diodes using the current from the current source to cause the one or more light emitting diodes to emit light substantially uninterrupted when changing between providing the voltage from the voltage source to driving the one or more light emitting diodes using the current source.

2. The display device of claim 1, wherein the pixel driving circuitry is configured to disconnect the voltage source in response to the one or more light emitting diodes approximately illuminating.

3. The display device of claim 1, wherein the pixel driving circuitry is configured to cause voltages of anodes of the one or more light emitting diodes to correspond to voltages of one or more capacitors associated with the one or more light emitting diodes.

4. The display device of claim 3, wherein the pixel driving circuitry is configured to cause the anodes to discharge charges stored in the one or more capacitors to cathodes of the one or more light emitting diodes.

5. The display device of claim 3, wherein the display device comprises a discharge switch configured to discharge charges stored in the one or more capacitors.

6. The display device of claim 1, wherein the current source drives the one or more light emitting diodes in parallel using the current source.

7. The display device of claim 1, wherein the pixel driving circuitry is configured to cause a driver to drive the one or more light emitting diodes using the voltage source, the current source, or both, in one or more phases.

8. The display device of claim 1, wherein the illumination threshold is based at least in part on a luminance floor.

9. A method, comprising:
drive one or more light emitting diodes of a display via a voltage source until approximately the one or more light emitting diodes are approximately illuminating;
switch to driving the one or more light emitting diodes using a current source; and
discharge charges associated with the one or more light emitting diodes using one or more discharge switches.

10. The method of claim 9, wherein in response to the one or more discharge switches turned on, the charges discharge through the one or more discharge switches.

11. The method of claim 9, wherein in response to the one or more discharge switches turned off, the charges discharge through the one or more light emitting diodes.

12. The method of claim 9, wherein the one or more discharge switches discharge the charges without causing the one or more light emitting diodes to illuminate.

13. The method of claim 9, wherein driving via the voltage source comprises driving in three phases.

14. The method of claim 13, wherein the three phases comprise an initial pre-charge period, a sampling period, and a pre-charge period.

15. The method of claim 14, wherein voltage characteristics of the one or more light emitting diodes are sampled during the initial pre-charge period, the sampling period, or a combination thereof, and wherein the a pre-charge period is based on the sampled voltage characteristics is applied to a gate of a pre-charge transistor for driving the one or more light emitting diodes using the voltage source.

16. The method of claim 9, wherein the switching occurs at a rising edge of an emission clock corresponding to a gray level of a highest quarter of a gray level range, wherein the gray level range comprises gray levels of 2 to a power of a particular bit-depth image.

17. The method of claim 9, wherein discharging comprises passing a charge stored in one or more capacitors of the one or more light emitting diodes through the one or more discharge switches.

18. A non-transitory computer-readable medium, comprising computer-executable instructions that, when executed by one or more processors, cause the one or more processors to:
drive one or more light emitting diodes of a display via a voltage source until approximately the one or more light emitting diodes are approximately illuminating;
switch to driving the one or more light emitting diodes using a current source; and
discharge charges associated with the one or more light emitting diodes using one or more discharge switches.

19. The non-transitory computer-readable medium of claim 18, wherein discharging comprises one or more anodes of the one or more light emitting diodes to discharge charges stored in one or more capacitors associated with the one or more light emitting diodes to one or more cathodes of the one or more light emitting diodes.

20. The non-transitory computer-readable medium of claim 18, wherein the switching occurs at a rising edge of an emission clock corresponding to a gray level.
